(19) United States
(12) Patent Application Publication
(10) Pub. No.: US 2010/0212631 A1
(43) Pub. Date: Aug. 26, 2010

(54) COMBUSTION ENGINE AND METHOD OF CONTROLLING A COMBUSTION ENGINE

(75) Inventors: Maxime Makarov, Viroflay (FR); Andre Agneray, Boulogne (FR); Marc Bellenoue, St Georges Les Baillargeaux (FR); Julien Sotton, Jaunay-Clan (FR); Serguei Labuda, Poitiers (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne Billancourt (FR)

(21) Appl. No.: 12/670,402

(22) PCT Filed: Jul. 21, 2008
(86) PCT No.: PCT/FR08/51373

§ 371 Date: May 4, 2010

(30) Foreign Application Priority Data
Jul. 25, 2007 (FR) 07 05437

(51) Int. Cl. F02P 5/04; F02P 1/00; H01T 13/20

(52) U.S. Cl. 123/406.19; 123/149 F; 123/169 E

(57) ABSTRACT

An internal combustion engine including: a pulse current generator; at least one electrode including at least one tip; a mechanism controlling the electrical supply to the electrode by the generator; and a combustion chamber in which the tip of the electrode is positioned, the tip being separated from the inner wall of the chamber by a minimum separation distance. The current generator and the electrode are configured such that the power density generated while the electrode is being supplied is less than 10⁵ watts per cubic centimeter, this power density being equal to the electrical supply power of the electrode divided by the minimum separation distance cubed.

The present invention relates in general to the field of the ignition of a fuel/oxidizer mixture in a combustion chamber of an internal combustion engine.

More particularly, the invention relates to an internal combustion engine comprising:
a pulse current generator;
at least one electrode provided with at least one tip;
a means for controlling the electric power supply to said electrode by said generator; and
a combustion chamber in which the tip of said electrode is positioned, this tip being separated from the inner wall of the chamber by a minimum separation distance (D).

The invention also relates to a method for controlling an internal combustion engine comprising:
a pulse current generator;
at least one electrode provided with at least one tip;
a means for controlling the electric power supply to said electrode by said generator; and
a combustion chamber in which the tip of said electrode is positioned, this tip being separated from the inner wall of the chamber by a minimum separation distance (D);
a piston mounted slidingly in the chamber between a top dead center position and a bottom dead center position.

The combustions in a combustion chamber are frequently not phased at the most appropriate times to optimize the running of an engine. A dispersion of the ignition time from one cycle to another or from one engine speed to another can reduce the efficiency of the engine and may promote the generation of pollutants or unburnts.

In this context, it is an object of the present invention to propose an engine and a method for better controlling the ignition time of the oxidizer/fuel mixture in the combustion chamber.

For this purpose, the engine of the invention, which also conforms to the generic definition provided in the introduction defined above, is essentially characterized in that the current generator and the electrode are designed so that the power density (R) generated during the power supply to said electrode is lower than 10⁵ watts per cubic centimeter, this power density (R) being equal to the electric power supply (Pmax) of said electrode divided by the minimum separation distance (D), cubed.

For this same purpose, the control method of the invention, which also conforms to the generic definition provided in the introduction defined above, is essentially characterized in that a mixture of oxidizer and fuel is sent into the combustion chamber and when the piston passes from its bottom dead center position toward its top dead center position, prior to the arrival of the piston at the top dead center, a pulse current is generated to supply said electrode, such that the power density generated during the power supply to said electrode is lower than 10⁵ watts per cubic centimeter, this power density being calculated by dividing the electric power supply of said electrode by the minimum separation distance, cubed.

For the understanding of the invention, it should be noted that the “minimum separation distance D” is the shortest measurable distance in a straight line between the tip of the spark plug electrode and the chamber wall and without intersecting an element of this spark plug. This minimum distance is therefore the shortest path between the tip of the spark plug electrode and the ground electrode formed by the chamber wall. If an electric discharge were to occur between the tip of this electrode and the chamber wall, the minimum length of the electric arc formed by this discharge would then be equal to this minimum distance D.

Thus, the risk of occurrence of an electric discharge is determined by the minimum distance D and the power supply to the electrode, or even by the power density which is a function of the power supply and this minimum distance D.

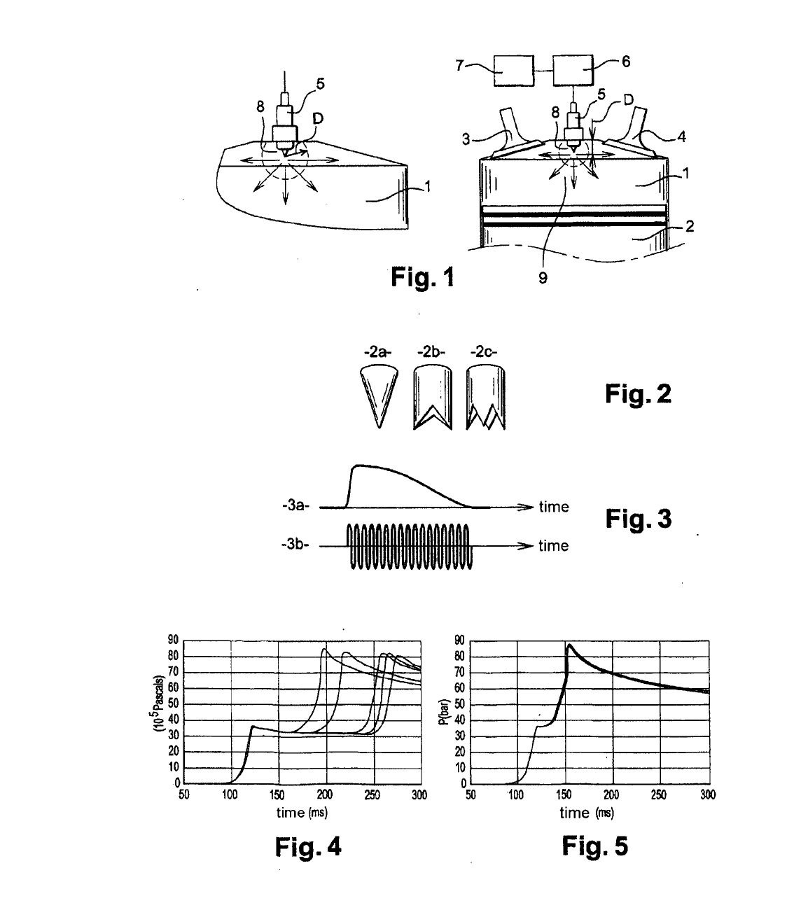

On this subject, see the detailed view at the left of FIG. 1 which shows an enlarged side view of the chamber and the spark plug shown in FIG. 1. The abovementioned minimum distance D is visible in the enlarged side view and also in FIG. 1. It should be noted that the spark plug comprises a single tipped electrode which is electrically insulated from the inner chamber wall. Preferably, this inner wall constitutes a ground electrode.

For the understanding of the present invention, it should be noted that the power supply denoted below by Pmax is the average power, that is the average value of the electric power delivered to the electrode over an uninterrupted period of supply to this electrode.

In other words, the generator and the spark plug are designed so that the power density which is denoted below by R and defined by R=Pmax/D³ is such that R<10⁵ watts/cm3.

This design of the generator and the electrode ensures that, when the electrode is supplied with power, the air surrounding the electrode is ionized without the temperature of this air exceeding an ignition threshold of the oxidizer/fuel mixture. This local ionization without ignition of the mixture is used to generate free radicals such as ozone and/or intermediate hydrocarbon species produced by the ionization.

This results in a stratification of the mixture contained in the chamber, with zones which are more or less rich in ionized air and free radicals.

Thanks to this chemical stratification, the autoignition time of the mixture can be determined with greater accuracy, which serves to prevent an excessive dispersion of the autoignition time.

It is observed that the autoignition of the oxidizer/fuel mixture is preferably initiated at the location of the stratum containing the free radicals and/or hydrocarbon species produced by the ionization when the pressure and temperature conditions in the chamber are satisfied.

Preferably, the invention is applied to HCCI type engines, that is engines in which the combustion is not initiated by a spark plug, but in which the combustion is auto-initiated when only the conditions of pressure, temperature and mixture composition in the chamber are satisfied. For this type of autoignition engine, the ionization of the mixture by power supply to the electrode serves to prepare the autoignition by creating preferable autoignition zones, without it necessarily being the power supply to the electrode that initiates this ignition. In fact, on this type of engine, the autoignition may take place even if the electrode is no longer supplied with power.

The creation of such preferable autoignition zones/strata by a local modification of the chemical properties of the mixture serves to avert the danger of a sudden mass combustion in the combustion chamber.

The supply of the electrode with a low level of electric power also conserves energy in comparison with supply with high electric power.

It is possible for example to ensure that the power density generated during the power supply to said electrode is lower than 10⁴ watts per cubic centimeter.

This embodiment serves to define a power density range for which it is certain that no autoignition can be initiated by the ionization, at the time of this ionization, the autoignition only occurring later, once the pressure in the chamber has increased owing to the rise of the piston toward the top dead center of the engine. Thus, the autoignition is not initiated by the electrode but is initiated by the pressure and temperature conditions, thereby improving the quality of the combustion.

It is for example possible to ensure that the power density R generated during the power supply to said electrode is between 10² and 10⁴ watts per cubic centimeter.

This embodiment serves to define a range for which it is certain that no autoignition can be initiated by the ionization alone, and for which it is certain that the level of ionization is sufficient to reduce the autoignition dispersions significantly.

It is for example possible to ensure that the pulse current generator is suitable for generating a single pulse current.

This embodiment facilitates the development of the electric power supply of the engine because only the power transmitted and the discharge rate need to be defined.

It is possible for example to ensure that the pulse current generator is suitable for generating an alternating current.

This alternative embodiment to the one before serves to provide an ionization of the mixture over a longer period than in the single pulse embodiment, thereby promoting the creation of ionized strata having a larger volume.

In this embodiment, the pulse current generator is preferably suitable for generating an alternating current having a frequency between 1 and 10 megahertz and preferably between 1 and 5 megahertz. This choice of frequency appears to be desirable for improving the quantity of free radical species produced.

With reference to the abovementioned inventive method, it is possible to ensure that the conditions are created for autoignition of the mixture of oxidizer and fuel by increasing the pressure in said combustion chamber by moving the piston toward its top dead center position and, prior to the autoignition of said mixture, it is ensured that the supply of pulse current to said electrode is interrupted.

This embodiment serves to prevent the ignition from being initiated by the electrode, this ignition being self-initiated as soon as the pressure and temperature conditions in the chamber are satisfied.

According to a preferred embodiment of the inventive method, the duration of the pulse current supply to the electrode is made to be between 1 and 20 milliseconds. This duration corresponds to the time required to generate sufficient free radicals and to allow repeatable autoignition over time.

Also according to the inventive method, the pulse current supplied to the electrode is made to be either a single pulse current, or a radiofrequency current having a frequency between 1 and 5 megahertz.

For the use of the engine and the method of the invention, the power density R generated by the generator around the electrode is such that the temperature around the electrode at the ionization time is lower than 800 K and preferably lower than 500 K. This feature prevents the power supply to the electrode from causing the ignition.

Other features and advantages of the invention will appear clearly from the description that follows, provided for information and in no way limiting, with reference to the appended drawings, in which:

FIG. 1 shows a cross section of a combustion chamber of an engine according to the invention;

FIG. 2 shows three types of electrodes which may be suitable for the implementation of the invention;

FIG. 3 shows two types of electric power supply currents which may be suitable for supplying the electrode of an engine of the invention;

FIG. 4 shows curves of pressure change in a combustion chamber of an engine of the prior art, each curve in this figure corresponds to a specific engine cycle, the superimposition of these curves on the same graph shows the dispersion over time of the autoignition times between the different engine cycles;

FIG. 5 shows a similar graph to that of FIG. 4 but in which the pressure change measurements are taken on an engine according to the invention, this graph showing the reduced dispersion of the autoignition.

As stated above, the invention relates to an internal combustion engine like the one shown in FIG. 1. This engine comprises a combustion chamber 1 in which a mobile piston slides between a top dead center point in which the volume of the chamber is a minimum and a bottom dead center point in which the volume of the chamber is a maximum. This engine comprises a single tipped electrode whereof the tip is placed inside the chamber at a distance D from the inner wall of the chamber. This distance D is the minimum distance (measured in a straight line and without obstacles) between the tip of the electrode and the wall, this distance being a factor determining the maximum electric power permissible by the electrode without this electrical energy being discharged on the chamber wall.

The electrode 5 is selectively supplied by a pulse current generator 6 according to a command generated by a control means 7. The metal electrode 5 is tipped and is electrically insulated by a ceramic body from the wall of the combustion chamber 1 also called cylinder head. When supplied by the current generator with a voltage of 20 to 30 kV, the electrode causes the formation of a corona discharge, which may or may not be associated with a uniform discharge known by the term of glow discharge 8. This type of discharge appears when the electric power supply density is lower than 10⁵ watts per cubic centimeter. It should be noted that this power density R is equal to the average electric power supply Pmax of said electrode 5 divided by the minimum separation distance D, cubed. This discharge modifies the chemical composition of the gas by causing a partial cracking of this gas in a zone limited to a few millimeters, or even to 1 or 2 centimeters around the tip of the electrode.

Preferably, both for the engine and for the method of the invention, the power supply to the electrode for this partial cracking is made to take place after the valves 3 and 4 of the engine are closed and shortly before the start of the compression or during this compression.

The energy or power supply to the electrode is made to be selected by the control means 7 which is a computer, this power being variable according to the engine speed. Preferably, the power supply duration is selected to be between 1 and 20 milliseconds. The partial cracking thus obtained produces free radicals and/or intermediate hydrocarbon species initially in the zone 8 near the tip of the electrode 5. During the compression, the preferably swirl turbulence broadens the stratification zone 9 which contains the partial cracking products.

Whilst the piston passes from its bottom dead center to its top dead center and subsequent to the electric power supply to the electrode which has allowed the cracking, the pressure in the chamber increases until the autoignition of the air/fuel mixture is initiated. This initiation occurs in particular in the zones containing free radicals and/or intermediate hydrocarbon species.

FIGS. 2a, 2b and 2c show three types of electrodes respectively having one, two or four tips, each of these electrodes being suitable for forming the electrode of the engine according to the invention and for implementing the inventive method. It has been found that it is preferable for an electrode to have no more than four tips in order to enhance the quality of the discharge.

Preferably, the tip or tips of each electrode are made to comprise a tip radius of curvature of between 10 and 100 μm.

Each of these electrodes may be supplied in the single pulse mode with an electric current like the one in FIG. 3a or with a multi-pulse current with an alternating electric current having a frequency of 1 and 5 megahertz. In each of the cases, the power supply is caused to be limited below a level that would be liable to generate a premature ignition and above a level allowing the partial cracking.

For this purpose, the power supply density of said electrode must be between 10² and 10⁴ watts per cubic centimeter and the duration of this power supply must be between 1 and 20 ms.

FIGS. 4 and 5 each show examples of changes in pressure in engine combustion chambers for portions of engine cycles in which the autoignitions occur.

For each given pressure curve, the change in pressure in the chamber 1 is plotted as a function of time, this chamber containing a propane/air mixture with a richness (fuel/air ratio) of 0.5. The first pressure rise is due to the compression, that is the movement of the piston from its bottom dead center to its top dead center.

The second pressure rise offset in time compared to the first corresponds to the autoignition of the mixture.

In FIG. 4, which shows the running of an engine of the prior art, it is observed that the time interval between the start of the first pressure rise (around 100 milliseconds) and the start of the second pressure rise varies according to the cycles, and a disparity of practically 100 ms can be observed between an early autoignition cycle and a late autoignition cycle.

By contrast, in FIG. 5 which shows the running of an engine according to the invention and running according to the inventive method, it is found that the distortion of the ignition time interval between different cycles is practically zero. It is thus easier to anticipate the autoignition time from one engine cycle to another by causing a partial cracking by supplying the electrode with reduced power prior to the autoignition.

1-10. (canceled)

11. An internal combustion engine comprising:
a pulse current generator;
a spark plug including a single electrode with at least one tip;
means for controlling electric power supply to the electrode by the generator; and
a combustion chamber in which the tip of the electrode is positioned, the tip being separated from the inner wall of the chamber by a minimum separation distance and the electrode being electrically insulated from the inner wall,
wherein the current generator and the electrode are configured so that power density generated during power supply to the electrode is between 10² watts per cubic centimeter and 10⁵ watts per cubic centimeter, the power density being equal to average electric power supply of the electrode divided by the minimum separation distance, cubed.

12. The internal combustion engine as claimed in claim 11, wherein the current generator and the electrode are configured so that the power density generated during the power supply to the electrode is lower than 10⁴ watts per cubic centimeter.

13. The internal combustion engine as claimed in claim 12, wherein the current generator and the electrode are configured so that the power density generated during the power supply to the electrode is between 10² watts per cubic centimeter and 10⁴ watts per cubic centimeter, the generator having a maximum limit of power that can be generated defined so that the power density is always lower than 10⁴ watts per cubic centimeter.

14. The internal combustion engine as claimed in claim 11, wherein the pulse current generator is configured to generate a single pulse current.

15. The internal combustion engine as claimed in claim 11, wherein the pulse current generator is configured to generate an alternating current.

16. The internal combustion engine as claimed in claim 15, wherein the pulse current generator is configured to generate an alternating current having a frequency between 1 and 10 megahertz or between 1 and 5 megahertz.

17. A method for controlling an internal combustion engine comprising:
a pulse current generator;
a spark plug including a single electrode with at least one tip;
means for controlling the electric power supply to the electrode by the generator; and
a combustion chamber in which the tip of the electrode is positioned, the tip being separated from the inner wall of the chamber by a minimum separation distance and the electrode being electrically insulated from the inner wall;
a piston mounted slidingly in the chamber between a top dead center position and a bottom dead center position, wherein a mixture of oxidizer and fuel is sent into the combustion chamber and when the piston passes from its bottom dead center position toward its top dead center position, prior to arrival of the piston at the top dead center, a pulse current is generated to supply the electrode, such that power density generated during power supply to the electrode is between 10² watts per cubic centimeter and 10⁵ watts per cubic centimeter, the power density being calculated by dividing average electric power supply of the electrode by the minimum separation distance, cubed.

18. The method as claimed in claim 17, wherein the conditions are created for autoignition of the mixture of oxidizer and fuel by increasing pressure in the combustion chamber by moving the piston toward its top dead center position and, prior to the autoignition of the mixture, the supply of pulse current to the electrode is interrupted.

19. The method as claimed in claim 17, wherein duration of the pulse current supply to the electrode is made to be between 1 and 20 milliseconds.

20. The method as claimed in claim 17, wherein the pulse current supplied to the electrode is made to be either a single pulse current, or a radiofrequency current having a frequency between 1 and 5 megahertz.
